(19) United States
(12) Patent Application Publication
(10) Pub. No.: US 2003/0177255 A1
(43) Pub. Date: Sep. 18, 2003

(54) Encoding and decoding system for transmitting streaming video data to wireless computing devices

(76) Inventor: David C. Yun, Vallejo, CA (US)

Correspondence Address: Geoffrey T. Staniford, Dergosits & Noah LLP, Suite 1450, Four Embarcadero Center, San Francisco, CA, 94111, US

(21) Appl. No.: 10/099,066

(22) Filed: Mar. 13, 2002

(51) Int. Cl. G06F 15/16

(52) U.S. Cl. 709/231

(57) ABSTRACT

A system of compressing streaming digital data for transmission from a computer to a remote computing device over a network is described. An encoding process in the computer compresses pre-stored or live streaming data consisting in a series of frames for transmission to the remote computing device. The encoding process compares a first frame of data within the streaming digital data to a second frame of data within the streaming digital data, the first and second frames comprising one or more bytes of data. A horizontal bit is set to a first logical value for each bit that differs in a byte of the first frame from a corresponding bit in the corresponding byte of the second frame, and a vertical bit is set for each byte in which a horizontal bit value is set to the first logical value. The vertical and horizontal bit information, along with the data for the second frame is transmitted to the remote computing device. The remote computing device includes a decoder process that determines which vertical and horizontal bits are set, the vertical and horizontal bits specifying pixel locations within a display screen array. The decoder process then writes the data to the pixel locations specified by the vertical and horizontal bits.

### FIELD OF THE INVENTION

The present invention relates generally to computer networks, and more specifically to an encoding/decoding system for compressing and transmitting streaming digital data to remote portable computing devices.

### BACKGROUND OF THE INVENTION

Portable, hand-held computing devices, such as Personal Digital Assistants (PDA's) have become popular accessories for allowing people to perform limited computing tasks, such as storing contact information, providing calendar and calculator fimctions, and performing light word processing. For mobile computer users, the computing power of these portable devices is often sufficient to perform only minimal computing tasks, however their small size and portability is often much more convenient compared to laptop or notebook computers. To increase their utility, manufacturers have evolved these devices from stand-alone units to communication devices that provide network interface capability. For example, newer generation PDA devices provide wireless or hardwired network interfaces that allow access to the Internet or other computer networks.

Although present portable computing devices feature advanced networking capabilities, such as web browsing capabilities, their limited computing power prevents their efficient use as true network client computers for the full-spectrum of multimedia content often available over the Internet or other local or wide-area networks. One of the major factors in this limitation is the availability of the proper technology to bring streaming media onto the handheld devices. Compared to typical desktop and laptop computers, portable handheld devices feature rather limited power of 19.2 kps transfer rates and an average of 16 Mhz processing speeds. This reduces their usefulness in providing playback for many types of digital content available over the networks, and results in a general lack of media content available on the handheld devices

What is needed therefore, is a digital data transmission system that accommodates a balance of high compression with minimal decoding processing power to allow streaming video data to be transmitted to handheld devices with minimum processing power, memory capacity and network interface capabilities.

### SUMMARY OF THE INVENTION

A system of compressing streaming digital data for transmission from a computer to a remote computing device over a network is described. An encoding process in the computer compresses pre-stored or live streaming data consisting in a series of frames for transmission to the remote computing device. The encoding process compares a first frame of data within the streaming digital data to a second frame of data within the streaming digital data, the first and second frames comprising one or more bytes of data. A horizontal bit is set to a first logical value for each bit that differs in a byte of the first frame from a corresponding bit in the corresponding byte of the second frame, and a vertical bit is set for each byte in which a horizontal bit value is set to the first logical value. The vertical and horizontal bit information, along with the data for the second frame is transmitted to the remote computing device. The remote computing device includes a decoder process that determines which vertical and horizontal bits are set, the vertical and horizontal bits specifying pixel locations within a display screen array. The decoder process then writes the data to the pixel locations specified by the vertical and horizontal bits.

The compression system of the present invention takes advantage of the processing power and memory capacity available on typical desktop computers for the purpose of encoding of the digital data. The encoded video stream is efficiently compressed using base frame and progressive frame processing to achieve video frame rate decompression as fast as 30 frames per second on handheld devices with limited resources. Embodiments of the present invention provide a compression algorithm and a small footprint decoder engine that overcome the memory and processing power limitations of typical portable wireless client devices and allow the efficient transmission and playback of streaming video and other digital data.

Other objects, features, and advantages of the present invention will be apparent from the accompanying drawings and from the detailed description that follows below.

### BRIEF DESCRIPTION OF THE DRAWINGS

The present invention is illustrated by way of example and not limitation in the figures of the accompanying drawings, in which like references indicate similar elements, and in which:

FIG. 1 illustrates a computer network consisting of a desktop computer coupled to one or more portable computing devices, that can be used to implement embodiments of the present invention;

FIG. 2 is a block diagram of the modules that comprise the decoder process, according to one embodiment of the present invention;

FIG. 3 is a flowchart illustrating the steps of encoding a stream of video data, according to one embodiment of the present invention;

FIG. 4 illustrates an exemplary construction of a progressive frame by the encoding process of FIG. 3;

FIG. 5 is a flowchart illustrating the steps of decoding a compressed video data stream, according to one embodiment of the present invention;

FIG. 6 illustrates the structure of the encoded and compressed data stream, according to one embodiment of the present invention;

FIG. 7 illustrates the arrangement of the header blocks for multiple compressed progressive frame data, according to one embodiment of the present invention;

FIG. 8 is a table that illustrates supported resolution and sizes for the encoding and decoding process, according to embodiments of the present invention; and

FIG. 9 illustrates the relationship between one line of the compressed video data stream and the corresponding row of pixels within the associated image frame of the video display screen, according to embodiments of the present invention.

### DETAILED DESCRIPTION OF THE PREFERRED EMBODIMENT

A system for transmitting video data over a wireless link to one or more personal computing devices is described. In the following description, for purposes of explanation, numerous specific details are set forth in order to provide a thorough understanding of the present invention. It will be evident, however, to one of ordinary skill in the art, that the present invention may be practiced without these specific details. In other instances, well-known structures and devices are shown in block diagram form to facilitate explanation. The description of preferred embodiments is not intended to limit the scope of the claims appended hereto.

Aspects of the present invention may be implemented on one or more computers executing software instructions. According to one embodiment of the present invention, server and client computer systems transmit and receive data over a computer network, standard telephone line, or wireless data link. The steps of accessing, downloading, and manipulating the data, as well as other aspects of the present invention are implemented by central processing units (CPU) in the server and client computers executing sequences of instructions stored in a memory. The memory may be a random access memory (RAM), read-only memory (ROM), a persistent storage, such as a mass storage device, or any combination of these devices. Execution of the sequences of instructions causes the CPU to perform steps according to embodiments of the present invention.

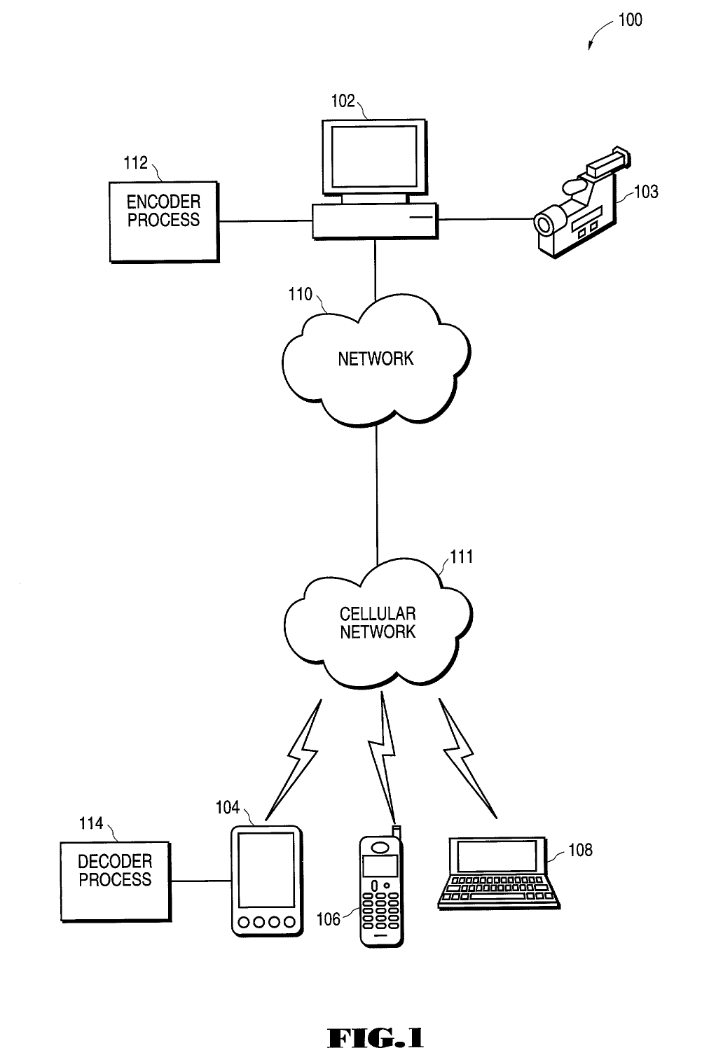

FIG. 1 illustrates a client server computer network that can be used to implement embodiments of the present invention. In network 100, server computer 102 is coupled to the one or more remote client computing devices 104 over a network 110. Network 110 may be any type of Local Area Network (LAN), Wide Area Network (WAN), or similar type of network for coupling a plurality of computing devices to one another. In one embodiment, network 110 is the Internet.

Server 102 transmits digital data over network 110 to the one or more client computing devices 104. Such data maybe video data, audio data, text data, or any combination thereof. The client computing devices are generally hand-held, personal digital assistant (“PDA”) devices 104, a data-enabled telephone or cellular phone (“SmartPhone”) 106, or some other type of portable, hand-held Internet access device 108. Such devices may be coupled to network 110 over a wireless link. Popular PDA devices 104 that can be used with embodiments of the present invention include PALM O/S™ devices such as the PALM PILOT™, and WINDOWS CE™ devices such as PDA devices made by Casio, Hewlett-Packard, and Philips Corp. Similarly, an example of a SmartPhone 106 that can be used is the Qualcomm™ PdQ phone, which is a cellular phone with digital computing and display capabilities. Other devices include cellular phones equipped with the BREW™ OS platform by Qualcomm™. The remote client computing devices may be Internet-enabled devices that connect to the Internet using their own internal Internet browsing abilities, such as a web browser on a hand-held computer or PDA device. Other remote devices may be Wireless Application Protocol (WAP) devices that include built-in browser capabilities. In an alternative embodiment, the remote devices may also include non-handheld devices that are coupled to server 102, such as personal computers, laptop computers, web kiosks, or similar Internet access devices, such as the WebTV™ system.

For remote client computing devices 104 that access network 110 over a cellular telecommunications link, network 100 includes a cellular network 111 that provides the necessary interface to network 110. Such a cellular network 111 typically includes server computers for the service carriers and the cell sites that transmit and receive the wireless signals from the remote clients 104.

The remote computing device 104 typically features minimal processing power and memory resources compared to desktop or laptop computers. This has generally reduced its effectiveness in providing resource-intensive media playback functions, such as streaming video playback and storage. A compression process is utilized that efficiently allows the encoding and decoding of the data for playback on the remote computing devices illustrated in FIG. 1. In one embodiment of the present invention, server 102 executes an encoding process 112, which encodes the digital data to be transmitted over network 110 to remote client 104. The remote client 104 executes a decoder process 114 that decodes the transmitted digital storage for playback and/or local storage. The decoder process 114 is a small footprint process, that is, one that features a small compiled executable program size. This allows low processing requirements, minimum power consumption, and small memory size requirements for the remote client. The protocol between the encoder process 112 and the decoder process 114 does not require any specific formatting or transmission requirements from either network 110 or cellular network 111. In this regard, the encoder/decoder process is network agnostic.

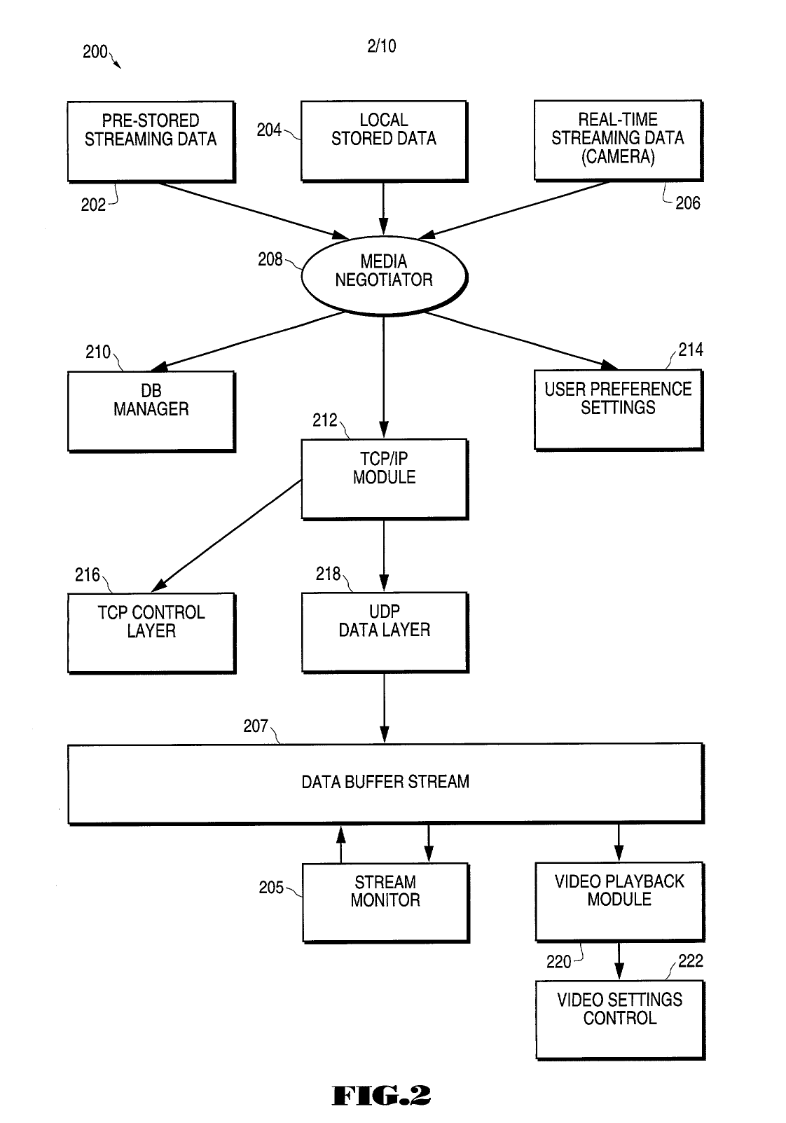

FIG. 2 is a block diagram of the program modules that comprise the decoder process 114 executed by the remote client 104, according to one embodiment of the present invention.

The remote client can receive and process several types of streaming data generated by the server 102, or other data sources coupled to network 110. In one embodiment, the source of data may be a digital camera 103 coupled to the server computer 102. The data received from the camera 103 is compressed by the encoder process 112 and then transmitted to the remote client 104 in real time, or is stored by server 102 for later transmission to the remote client 104. FIG. 2 illustrates the different sources of data that can be received by the remote client 104. Real-time streaming data 206 represents data that is captured by camera 103, compressed by encoder process 112 and then transmitted in real-time over network 110 to remote client 104 to be decoded by decoder process 114. Camera mode 206 allows the remote client to connect to a remotely coupled web enabled camera, such as camera 103. In this mode of operation, full motion video can be viewed in real-time. Pre-stored streaming data 202 represents data that is captured by camera 103 and then stored on server computer 102. The remote client 104 accesses the data file from its storage or archive location in the server computer and decodes the data through decoder process 114. Either real-time or pre-stored streaming data can be stored locally on the remote client 104. This data is represented by local stored data 204. Local mode 204, is typically used for the downloading of movies or other streaming video data onto the remote client 104 to be previewed offline.

Because embodiments of the present invention have applicability in various areas, such as telecommunications, entertainment, surveillance, interactive communication, and the like, the source of the digital data (video, audio, text, etc.) can be any number of different devices, besides digital camera 103. Furthermore, such devices can be coupled directly or indirectly to server computer 102, or they can be resident within the server computer. The compression rates and playback quality can be adjusted for distribution to specific remote client platforms. The server computer 102 may execute a preview process that provides a graphic interface that displays the data as it is generated by the camera 103, or other data source.

The compressed data provided to the remote client 102 as either real-time data 206, locally stored data 204, or pre-stored data 202, is first processed by a media negotiator module 208. This module communicates with other subordinate modules for correct media playback. A preference settings module 214 allows the user to define the settings for streaming options during playback mode, typically when the data source is a stream 202 or camera 206. A database manager module 210 controls the dynamic and static media content generated by the server computer 102. The TCP/IP module 212 performs the negotiation of the wireless TCP/IP layer. The TCP Control Layer 216 communicates control functions between the server 102 and the remote client 104. This layer can be configured to control the camera 103 functions, such as pan, tilt, zoom, focus, and so on. In this manner, the remote client 104 can exercise remote control over the data source through server 102. The UDP data layer 218 connects the UDP socket for data packet transmission. A data buffer stream 207 gets data packets from the UDP layer in specific datagram sizes. A separate stream monitor module 205 prevents the data buffer from overfilling or emptying, as well as preventing event driven mechanisms from blocking data transmission.

The decoding process 114 executed by the remote client 104 also consists of a video playback module 220 that processes the received data stream and decodes the encoded data. The core of the decoding engine resides in the video playback module 220. This module also communicates with the TCP control layer 216 to adjust playback speeds and other playback parameters. The video settings and control module 222 is provided to allow the user to control video image settings during playback mode on the remote client 104.

The video stream transmitted from the server 102 to the remote client 104 is coded into a specific video format that serves to compress the transmitted data. For embodiments in which the transmitted data is streaming video, the video stream is analyzed and processed in a frame-by-frame manner. As it is received, each current frame (“progressive frame”) is compared to the previous frame (“base frame”). The encoding/decoding process analyzes differences in pixel information between a base frame and the progressive frame, and generates coordinate information (referred to as horizontal and vertical bit information). The progressive frame and coordinate information represents the compressed data that is transmitted to the remote client which then decodes the compressed data to recreate the frame sequence.

The base frames generated by the server computer may be uncompressed video frames, or frames that are pre-compressed with the standard scanline or run length compression methods that are known to those of ordinary skill in the art. Alternatively, other proprietary compression methods that are compatible with handheld platform operating systems can be used.

The base frames, either compressed or uncompressed are masked with consecutive frames to create the coordinate system and the progressive frames. Base frames are generally transmitted at specified intervals to re-align the video frame sequences. Progressive frames are used to transmit the coordinate system of the masked data of each consecutive frame. All progressive frame coordinates are based upon the previous frame. In one embodiment of the present invention, the progressive frame with its coordinate system consists of a header, vertical bits, and the pixel data. The header is a three-byte data string that details the frame type and frame length. The vertical bits represent the horizontal row byte of a raster. For each byte (eight-bits) in a row byte, only one vertical bit is represented for that position. A vertical bit set at position zero represents the horizontal bits at position 0 to 7. If all the vertical bits are set to zero, this indicates that no change has occurred within that coordinate system. The pixel data consists of differential pixels masked from the base frame and the current frame.

For additional efficiency and compression, a half-mode frame can also be used to compress the frame size in half. This is accomplished by storing, in the encoder process 112, either the odd or even rows of the raster and processing the frames with a smaller resolution. For example, for an image resolution of 160×120, the image size is minimized to 160×60, skipping every other line from the vertical raster. To recreate the missing lines, the pixels are interpolated by the decoder process 114 by standard line doubling techniques, such as repeating adjacent line data.

Alternatively, the half-mode frame can be restored by a line doubling process that averages the values of its neighboring pixels. For this method the data values for the pixels in the line above and below the missing line are averaged to produce the data values for the corresponding missing pixels. If further refinement is required, more additional adjacent pixel values can be used in the averaging process to determine the data value of a missing pixel. This method generally provides for a smoother aliasing of high-contrast images and diagonal lines. For this averaging process of restoring a halfmode image using neighboring pixel data values.

Encoder Process

The progressive frame is encoded by comparing the current and previous row rasters. The row data at position zero of the previous frame is compared with the row at position zero of the current frame. This process of masking the current frame with the previous frame continues for every pixel.

During the process of the comparing each pixel, the horizontal bit is set only if there is a match, otherwise the values of the horizontal bit remains with its initialized value of zero. The vertical bit indicates which byte value has changed within a row, with binary 1 (set) indicating a changed value, and binary zero indicating no change.

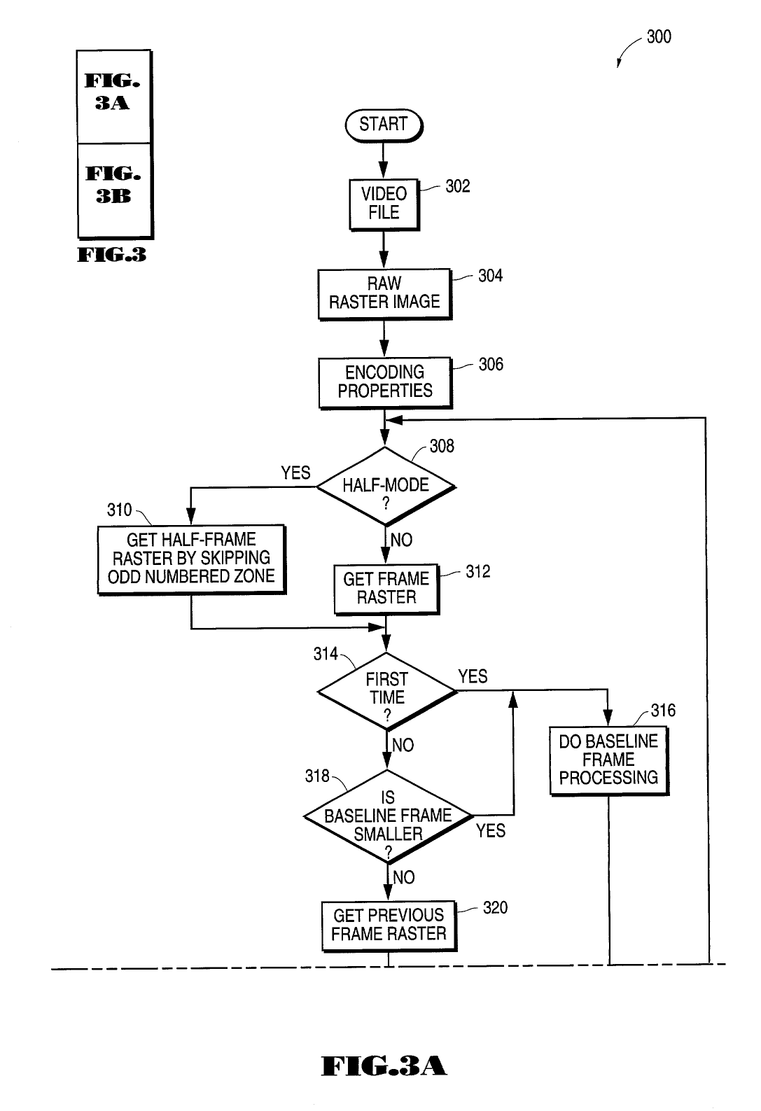

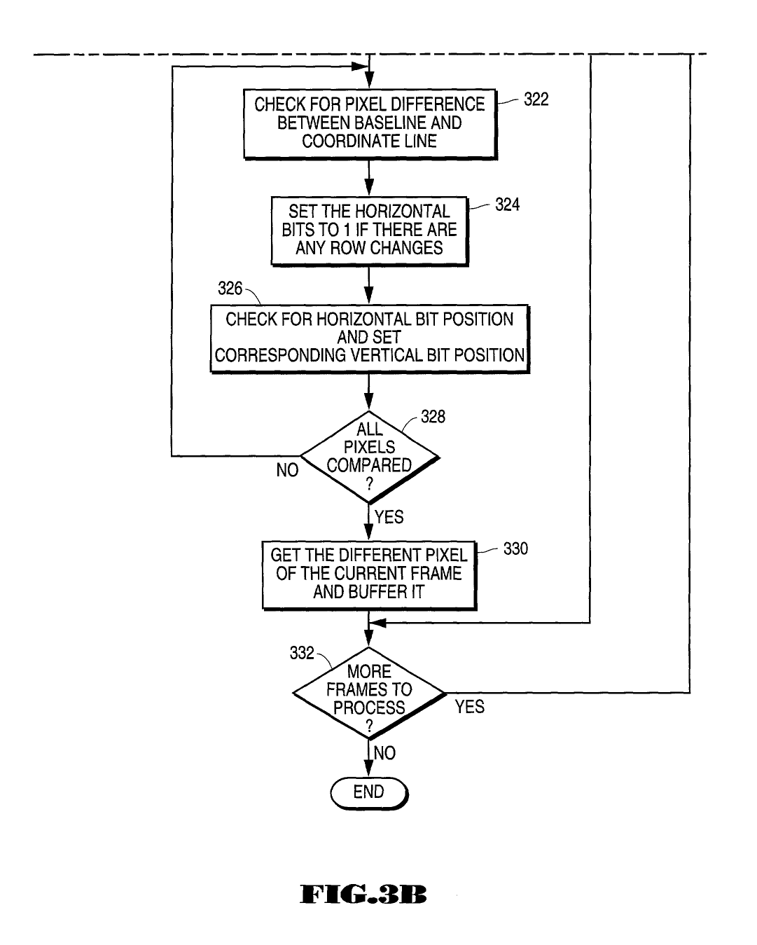

FIG. 3 is a flowchart illustrating the steps of encoding a stream of video data, according to one embodiment of the present invention. In step 302 the video file, or other streaming digital data is input to the process, and the raw raster image is then derived in step 304. In step 306 the encoding properties are set. The user may specify the quality of the encoding (high, medium, low) as well as the depth of the encoding, which is the number of bits used to represent a pixel. In step 306, the user also specifies whether halfmode encoding is employed. If half-mode encoding is not employed, as determined in step 308, the frame raster is obtained. If half-mode encoding is employed, the half frame raster is obtained by skipping the odd numbered rows. In step 314 it is determined whether the process is proceeding for the first time. For the first execution of the process, the method proceeds from step 316 in which base line frame processing is performed. In step 332 it is determined whether there are any further frames to process, If not the process ends, other wise the process continues from step 308.

If in step 314 it is determined that the process is not executing for the first time, the process determines whether the baseline frame is smaller than the present frame, step 318. If so, the process proceeds from step 316 with baseline frame processing. If the baseline frame is not smaller, the previous frame raster is obtained, step 320. The process then checks for pixel differences between the base line and coordinate line, step 322. The horizontal bits are set to one if there are any row changes, step 324. In step 326, the process checks for horizontal bit position and sets the corresponding vertical bit position. It is next determined whether all pixels have been compared; step 328. If not, the process loops from step 322 to check for pixel differences between the baseline and coordinate line. Once all of the pixels have been compared, the process proceeds from step 330 in which different pixels of the current frame are buffered. The process then continues from step 332 in which it is determined whether there are any further frames to process.

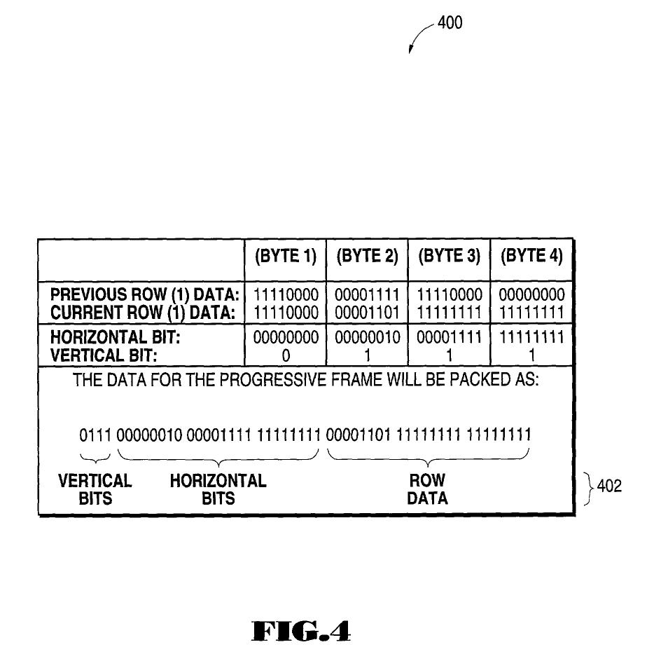

FIG. 4 illustrates an exemplary construction of a progressive frame by the encoding process of FIG. 3. The data consists of four bytes showing previous and current row bit values. For each byte, the current bits are assigned to the previous bits to generate the horizontal bit information. If a previous frame bit is the same as the current row bit, the corresponding horizontal bit is assigned a value of zero; and if it is not the same, the horizontal bit is assigned a value of one. For each byte, a single vertical bit is assigned. If any horizontal bit for a previous/current pair of row bytes is set, the vertical bit for the byte is set to one. Thus, any change between the previous row and current row in a byte will result in a vertical bit setting of one. If there is no change, and hence no horizontal bit set to one, the vertical bit is set to zero. As can be seen in Table 400 of FIG. 4, the previous and current row data for the first byte is unchanged from 11110000 to 11110000, therefore the horizontal bits are set to 00000000, and the corresponding vertical bit is set to 0. For bytes 2 through 4, there is at least one change between the previous and current rows. The horizontal bits are set to one in the bit positions that have changed, and for each of these bytes, the corresponding vertical bit is set to one.

The vertical bits, horizontal bits and row data are concatenated (packed) together to form the compressed progressive frame data. The compressed progressive frame data is generated by packing the vertical bits followed by the horizontal bits and then the row data for the current row. The vertical bits for all of the bytes are included, however only the horizontal bits and row data for bytes in which the corresponding vertical bit is set to one are included. Thus, for the example row data in Table 400, the compressed data is shown as string 402. The vertical bits 0111 are followed by the horizontal bits for bytes 2 through 4 and the row data for the current bytes 2 through 4.

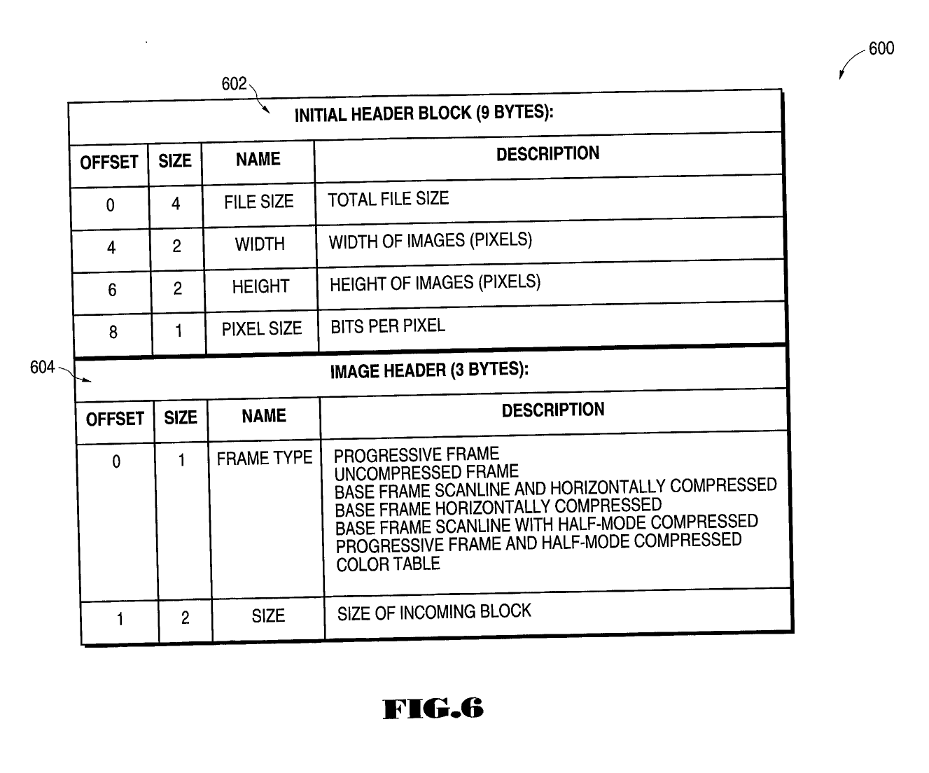

The compressed progressive row data is encoded with a specific structure that identifies the data stream as an appropriately compressed data stream. FIG. 6 illustrates the structure of the encoded and compressed data stream, according to one embodiment of the present invention. The encoded video stream is initially tagged with a nine byte header to indicate the video stream specifications, followed by a block of data with a three byte image header attached. The three byte image header data is repeated for each progressive frame block.

Table 600 of FIG. 6 illustrates the composition of the header information. The initial header block 602 specifies the file size, the width of the image, the height of the image, and the number of bits per pixel. The initial header block 602 is used only at the beginning of a compressed video stream. The initial header block 602 is followed by a three byte image header 604. The image header 604 specifies the frame type and frame size. The frame type bit of the image header codes the type of frame that is being transmitted. The possible types of frames include a progressive frame, uncompressed frame, base frame scanline and horizontally compressed, base frame horizontally compressed, base frame scanline with half-mode compressed, and progressive frame and half-mode compressed. If the image has a color table, the image header can be used to indicate the color table that is used to index the pixel values. If no color table is provided with the image, a system color table may be used.

The byte size and offset values shown in Table 600 for the initial and image header blocks are provided for purpose of illustration, and it should be noted that any appropriate size and offset values may be used.

After the image header 604, the compressed data follows. The actual pixel data is represented as a byte vector, where one to eight pixel values are stored in one byte, depending on the bit size of a pixel. If multiple pixels are in a single byte, the most significant bits correspond to the left-most pixel. For uncompressed images, the scanlines have a length that corresponds to the row length. For compressed images, the size value of the image header 604 indicates the length of the image data, which corresponds to the pixel data size plus two bytes for the size byte.

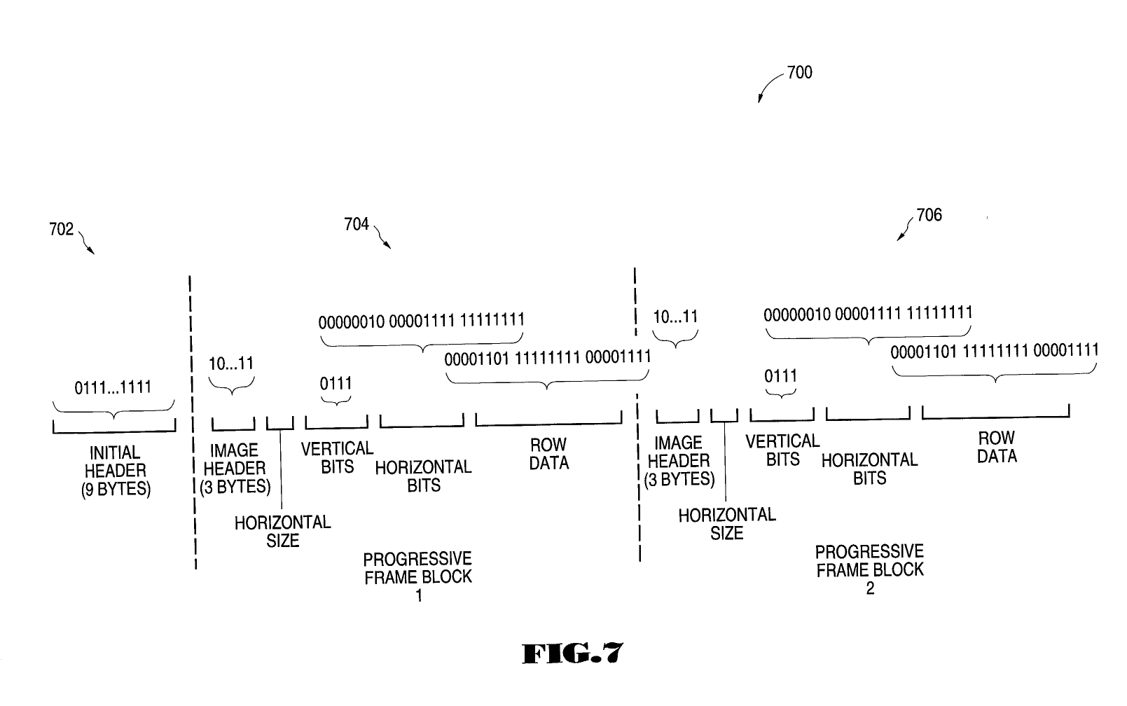

FIG. 7 illustrates the arrangement of the header blocks for multiple compressed progressive frame data, according to one embodiment of the present invention. In FIG. 7, two progressive frame blocks 704 and 706 are shown. Each comprises a three byte image header, such as image header 604, followed by vertical bit, horizontal bit, and row data, such as shown in FIG. 4. Each of the frame blocks 704 and 706 also includes a horizontal size value that specifies the size of the horizontal bit data. A nine byte initial block header 702 precedes the progressive frame block data.

Once the video streaming data for the progressive frames is encoded by the encoder process 112 of server computer 102, it is transmitted over network 110 to the remote client 104, where it is decoded using decoder process 114. As described previously, the compressed data can be transferred in real-time (camera mode) to the remote client, it can be stored on the server computer prior to transmission, or it can be stored locally on the remote client.

Decoding Process

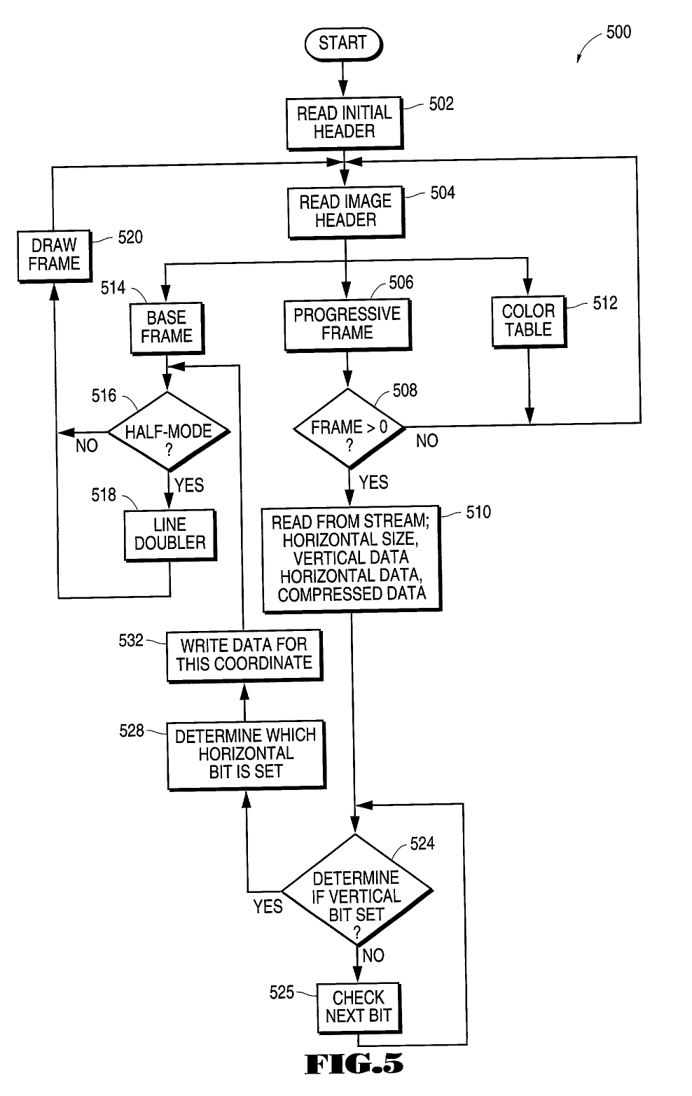

The decoding process 114 involves the decomposition of the encoder logic. The transmitted data is compressed to allow a single pass decompression that is suitable for CPU and memory limited devices, such as PDA and cell phones. FIG. 5 is a flowchart illustrating the steps of decoding a compressed video data stream, according to one embodiment of the present invention. The decoder process 114 starts by reading the initial header 602 to identify the incoming data stream as properly encoded data to be decoded, step 502. Validation of the incoming data stream as encoded data may be performed by comparing checksum values of one or more fields of the initial header block, such as the image width, height, and/or pixel size fields.

In step 504 the image header 604 is read. The frame type field is decoded to determine what type of frame data is encoded. If a base frame 514 is encoded, the process determines whether half-mode encoding was used, step 516. If so, the process performs a line doubling process, step 518. After the line-doubling process, or if half-mode encoding was not used, the frame is drawn, step 520. The process then proceeds from step 504 in which the next frame header is read. Similarly, if the encoded data is a color table 512, the process reads the next image header.

If the image data is a progressive frame 506, the process determines if the frame data exceeds zero, step 508. If not, the process loops back to step 504 to read the next image header. If, in step 508, it is determined that the frame value is greater than zero, the horizontal size, vertical data, horizontal data, and compressed image data is read from the data stream, step 510. In step 524, each byte is examined in a bit-wise fashion to determine if the vertical bit is set. If the currently checked vertical bit is not set, the process repeats through the next bit of the byte until the next set vertical bit is found, step 525. If a vertical bit is set, the process next determines in a bit-wise manner which horizontal bit is set, step 528.

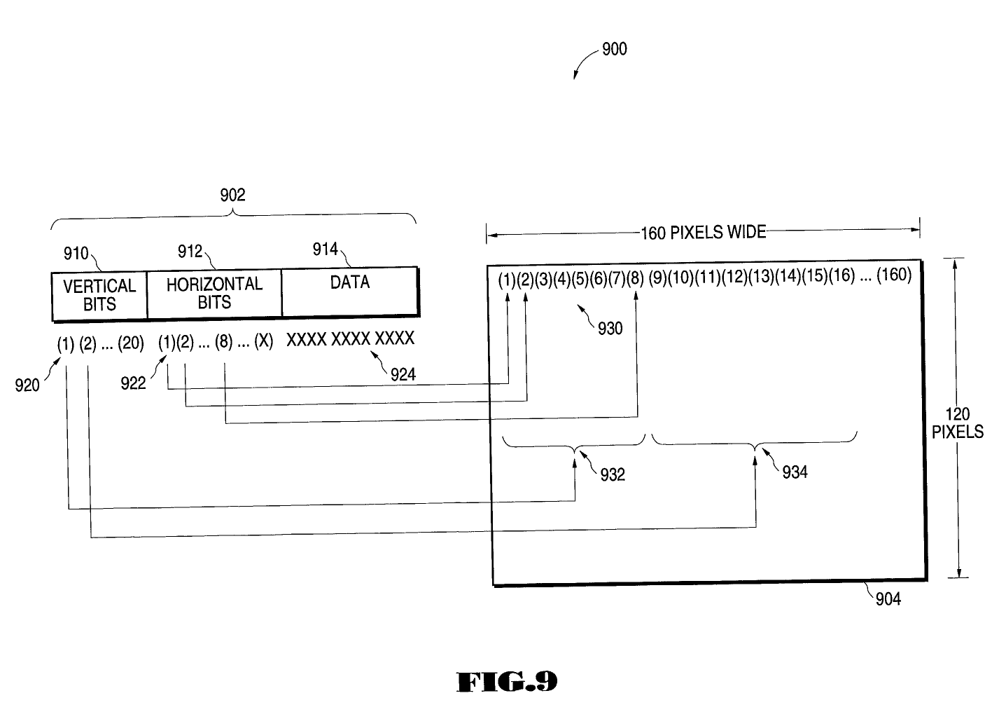

Once the set horizontal bits corresponding to the set vertical bits are found, the process then writes the data for the coordinate corresponding to these set vertical and horizontal bits, step 532. We turn next to a more detailed explanation of this decoding process, as illustrated in FIG. 9, as well as to some basic gray-scale/color mapping information, before turning back to the steps subsequent to step 532 of FIG. 5.

FIG. 9 illustrates the relationship between one line of the compressed video data stream and the corresponding row of pixels within the associated image frame of the video display screen, according to embodiments of the present invention. The illustration of FIG. 9 shows a ‘compressed data’-to-image mapping diagram 900 comprised of a single line of pixel data 902 and a corresponding image frame in an associated display screen 904. In this example, the display screen 904 consists of an array of 160 pixels across by 120 pixels in height, for a total number of 19,200 pixels to display an image (in 8-bit mode). Each of the 120 rows of pixels (associated with the 120 pixels in height shown on the right side of display screen 904) can be mapped from a single corresponding line of pixel data 902, although only the data corresponding to the first row is illustrated in FIG. 9.

Each of these corresponding lines of pixel data 902 includes a portion of vertical bits 910, a portion of horizontal bits 912 and a data portion 914. In the embodiment of FIG. 9, the portion of vertical bits 910 is comprised of one logical bit for each 8 pixels of the display screen 904 width. Here, these vertical bits are shown in a data field 920 that contains 20 logical bits, referenced as “(1) (2) . . . (20)” in FIG. 9. Each of these 20 vertical bits corresponds to 8 pixels out of the 160 pixels of total width, with arrows and brackets (as seen in FIG. 9) indicating how the first vertical bit corresponds to the first group of 8 pixels 932 and the second vertical bit corresponds to the second group of 8 pixels 934, according to the illustrated embodiment. Similarly, the 20^{th} vertical bit would correspond to the final 8 pixels out of the full 160 pixels of width. Each of these vertical bits, then, is set at ‘1’ (or a logic ‘high’) to indicate that the pixel data 902 includes a set of 8 bits, within the horizontal bits 912, to be mapped to the display screen 904.

FIG. 9 also illustrates how such a set of 8 horizontal bits (shown by “(1) (2) . . . (8)” within data field 922) corresponds to one of the 8-pixel groups that span the width of the display screen 904. This specific mapping regime of FIG. 9 illustrates an instance where the first logical bit of the vertical bits 910 is set at a logic high, which indicates that the first group of 8 logical bits within the horizontal bits field 912 corresponds (and can be mapped) to the first group of 8 pixels in the display screen width, as shown by the arrows pointing from logical bits 1 through 8 (within data field 922) to pixels 1 through 8 of the first group of eight pixels 930 present in the display screen 904 width. Finally, the data portion 914 of the pixel data contains logical data such as the row data contained with the frame blocks 704 and 706 of FIG. 7.

In a standard video display screen, such as on the right side of FIG. 9, each pixel is assigned a discrete location. With respect to the resulting image that is viewed, each pixel contains a value that represents a particular gray-scale level or color. In a preferred embodiment of the present invention, the data portion 914 component of the pixel data can be used to indicate or represent the particular gray-scale level or color. In this embodiment, each pixel is typically coded with a 4, 8, 16, 24 or 32 bit gray-scale or color value. If a 4-bit value is used, there are 16 possible gray-scale or color values for each pixel; if an 8-bit value is used, there are 256 possible values available, and so on. The vertical bits specify the vertical coordinate of the horizontal within the frame to be drawn, and the horizontal bits specify the horizontal coordinate of the pixel within the frame to be drawn. The data contains the gray-scale or color data for pixel located by the vertical and horizontal pixels.

With this understanding of the mapped, compressed pixel data 902, we now turn back to the steps following the write data step 532 in the flowchart of FIG. 5. After the data is written for the pixel located by the vertical and horizontal bits, the process then proceeds to step 516 in which it is determined if half-mode encoding is used to perform line doubling, and then the frame is drawn, in step 520.

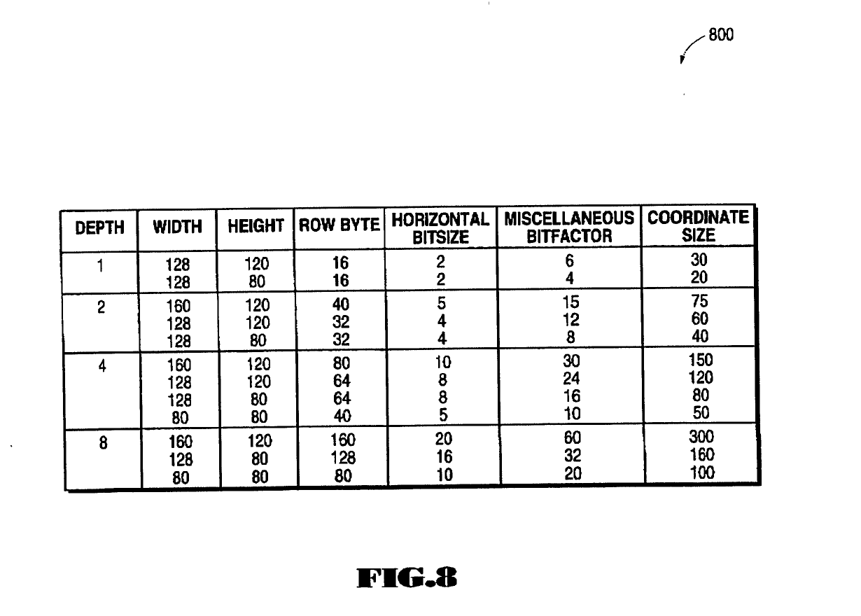

In one embodiment, the encoding/decoding process compresses the data on a byte aligned basis. This presents practical limits on the decoding resolution sizes. FIG. 8 is a table that illustrates supported resolution and sizes for the encoding and decoding process, according to embodiments of the present invention.

The possible supported sizes can be calculated using the following formulae for the variables provided in Table 800:

rowbyte=width×(depth/8 byte)

HorzBitSize=rowbyte×(⅛ byte)

MiscBitFactor=height×(HorzBitSize/40), where 40=(8-bits)×5 increments

CoordSize=height×(HorzBitSize/8 byte)

Although embodiments of the present invention have been described in relation to compressing streaming video data for encoded transmission between server and client computing devices, it should be noted that various other types of digital data can be compressed in accordance with the methods described herein. Such data can include streaming audio data, graphics data, text data, interactive chat data, and any other similar type of digital data or combinations thereof.

In the foregoing, a method and system has been described for compressing streaming digital data for transmission to remote personal computing devices. Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. A method of compressing streaming digital data for transmission from a computer to a remote computing device over a network, the method comprising:
receiving a first frame of data within the streaming digital data, the first frame comprising one or more bytes of data;
receiving a second frame of data within the streaming digital data, the second frame comprising one or more bytes of data;
performing a bit-wise comparison of each byte of the first frame of data with a corresponding byte of the second frame;
setting a horizontal bit value to a first logical value for each bit that differs in a byte of the first frame from a corresponding bit in the corresponding byte of the second frame; and
setting a vertical bit to a logical value for each byte in which a horizontal bit value is set to the first logical value.

2. The method of claim 1 further comprising the steps of concatenating the vertical bit data with the horizontal bit data and the second frame of data to form compressed digital data.

3. The method of claim 2 further comprising the step of appending a first header specifying a frame type and frame size to the compressed digital data.

4. The method of claim 3 wherein the digital data comprises streaming video data, and further comprising the step of appending an initial header specifying a size of the video data file, a width of the image in pixel count, a height of the image in pixel count, and a size of a pixel in a bit count.

5. The method of claim 3 wherein the frame type comprises one of: a subsequent frame, an uncompressed frame, a first frame scanline and horizontally compressed, a first frame horizontally compressed, a first frame scanline and half-mode compressed, a subsequent frame half mode compressed.

6. The method of claim 3 further comprising the steps of:
receiving the compressed digital data in the remote computing device;
determining the frame type from the first header;
reading horizontal size, vertical data, horizontal data, and compressed data from the digital data;
determining if the vertical bit is set to the logical value;
determining which horizontal bit is set if the vertical bit is set to the logical value;
writing compressed data for the corresponding horizontal bit; and
drawing the image data to a buffer in the remote computing device.

7. The method of claim 1 wherein the remote computing device comprises a portable computing device coupled to the network over a wireless link.

8. The method of claim 2 wherein the network comprises the Internet.

9. The method of claim 3 wherein the portable computing device comprises one of:
a personal computer, handheld personal digital assistant, and networkable cellular phone.

10. The method of claim 5, wherein the network comprises a TCP/IP network and the data transmitted over the network comprises one of: computer text data, streaming audio data, and streaming video data.

11. A system of compressing streaming digital data for transmission from a computer to a remote computing device through a network, the system comprising:
an encoding process in the computer that compares a first frame of data within the streaming digital data to a second frame of data within the streaming digital data, the first and second frames comprising one or more bytes of data;
a first compression process in the computer that sets a horizontal bit to a first logical value for each bit that differs in a byte of the first frame from a corresponding bit in the corresponding byte of the second frame;
a second compression process in the computer that sets a vertical bit is for each byte in which a horizontal bit value is set to the first logical value;
a transmission process that concatenates the vertical bit and horizontal bit information, with data comprising the second frame to form compressed data and transmits the compressed data to the remote computing device;
a decoder process in the remote computing device that determines which vertical and horizontal bits are set, the vertical and horizontal bits specifying pixel locations within a display screen array; and
a pixel drawing process that writes pixel value data to the pixel locations specified by the vertical and horizontal bits.

12. The system of claim 11 further comprising a process that appends a first header specifying a frame type and frame size to the compressed data.

13. The system of claim 12 wherein the digital data comprises streaming video data, and further comprising a process that appends an initial header specifying a size of the video data file, a width of the image in pixel count, a height of the image in pixel count, and a size of a pixel in a bit count.

14. The system of claim 11 wherein the remote computing device comprises a portable computing device coupled to the network over a wireless link.

15. The system of claim 11 wherein the network comprises the Internet.

16. The system of claim 11 wherein the remote computing device comprises one of: a personal computer, handheld personal digital assistant, and networkable cellular phone.

17. The system of claim 11, wherein the network comprises a TCP/IP network and the data transmitted over the network comprises one of: computer text data, streaming audio data, and streaming video data.
